(19) United States
(12) Patent Application Publication
(10) Pub. No.: US 2022/0056893 A1
(43) Pub. Date: Feb. 24, 2022

(54) POWER GENERATION FROM SUPERCRITICAL CARBON DIOXIDE

(71) Applicant: TerraCOH Inc., Bloomington, MN (US)

(72) Inventors: Philip Arthur Pogge, Eden Prairle, MN (US); Larry G. Chorn, Golden, CO (US)

(21) Appl. No.: 17/406,694

(22) Filed: Aug. 19, 2021

Related U.S. Application Data
(60) Provisional application No. 62/706,518, filed on Aug. 21, 2020.

(51) Int. Cl. F03G 4/00

(52) U.S. Cl. CPC F03G 4/045

(57) ABSTRACT

A system comprising a non-water working fluid feed stream, a compressor configured to compress the non-water based working fluid, to provide a compressed non-water based working fluid; and an energy recovery system configured to recover energy from the compressed non-water based working fluid, to provide a de-energized compressed non-water based working fluid, wherein the energy recovery system captures at least a portion of excess energy from the compressed non-water based working fluid and converts the captured excess energy to electricity, heat energy, or both electricity and heat energy.

### CROSS-REFERENCE TO RELATED APPLICATION

This application claims the benefit of priority to U.S. Provisional Patent Application Ser. No. 62/706,518 entitled “POWER GENERATION FROM SUPERCRITICAL CARBON DIOXIDE,” filed Aug. 21, 2020, the disclosure of which is incorporated by reference herein in its entirety.

### BACKGROUND

In response to global climate change, various systems have been developed. For example, in response to an increased desire to reduce dependence on fossil fuels, and in particular foreign oil supplies, renewable energy systems such as wind, solar, and geothermal-based systems are being increasingly researched and developed. In addition, in response to the rapidly increasing amount of carbon dioxide in the atmosphere, systems for the removal or sequestration of carbon dioxide have been developed. However, many such systems have only limited potential due to, for example, high costs, overall process inefficiencies, possible adverse environmental impact, and the like.

### SUMMARY

This disclosure describes working fluid feed systems that can more efficiently recover at least a portion of excess energy that might otherwise be underutilized from a compressed non-water based working fluid, such as highly compressed or supercritical carbon dioxide (“CO₂”), that is being supplied by the feed systems. The feed systems of the present application can recover at least a portion of the excess energy that might otherwise be unutilized and convert it to a form of energy that can be used internally within the same process or that can be used in another process, such as electricity, heat energy, or both. The non-water based working from which the excess energy has been recovered can then be used as a feedstock or working fluid in one or more processes involving the non-water based working fluid, such as geothermal energy recovery from a subterranean reservoir or sequestration of the working fluid in a subterranean reservoir.

The present disclosure describes a system comprising a non-water working fluid feed stream, a compressor configured to compress the non-water based working fluid, to provide a compressed non-water based working fluid, and an energy recovery system configured to recover energy from the compressed non-water based working fluid, to provide a de-energized impressed non-water based working fluid, wherein the energy recovery system captures at least a portion of excess energy from the compressed non-water based working fluid and converts the captured excess energy to electricity, heat energy, or both electricity and heat energy.

The present disclosure also describes a method comprising compressing a non-water based working fluid to provide, a compressed non-water based working fluid, and recovering at least a portion of excess energy from the compressed non-water based working fluid to provide a de-energized compressed non-water based working fluid and converting the recovered energy to electricity, heat energy, or both electricity and heat energy.

These and other examples and features of the present systems and methods will be set forth in part in the following Detailed Description. This Summary is intended to provide an overview of the present subject matter and is not intended to provide an exclusive or exhaustive explanation. The Detailed Description below is included to provide further information about the present systems and methods.

### BRIEF DESCRIPTION OF THE DRAWINGS

FIG. 1 is a simplified schematic diagram of a first example energy generation system.

FIG. 2 is a simplified schematic diagram of a second example energy generation system.

FIG. 3 is a simplified schematic diagram of a third example energy generation system.

FIG. 4 is a simplified schematic diagram of a fourth example energy generation system.

FIG. 5 is a simplified schematic diagram of an example prior art front-end feed system for delivering a supercritical non-water based working fluid to a geothermal reservoir.

FIG. 6 is a simplified schematic diagram of an example front-end feed system for compressing a non-water based fluid to a supercritical fluid and converting energy from the supercritical non-water based fluid to electricity, in order to provide a partially de-energized supercritical non-water based fluid for delivery to another process, in accordance with the present disclosure.

FIG. 7 is a simplified schematic diagram of another example front-end feed system for compressing a non-water based fluid to a supercritical fluid and converting energy from the supercritical non-water based fluid to electricity, in order to provide a partially de-energized supercritical non-water based fluid for delivery to another process, in accordance with the present disclosure.

FIG. 8 is a simplified schematic diagram of an example front-end feed system for compressing a non-water based fluid to a supercritical fluid and recovering heat energy from the supercritical non-water based fluid to provide a cooled supercritical non-water based fluid for delivery to another process, in accordance with the present disclosure.

FIG. 9 is a simplified schematic diagram of another example front-end feed system for compressing a non-water based fluid to provide a supercritical fluid and recovering heat energy from the supercritical non-water based fluid to provide a cooled supercritical non-water based fluid for delivery to another process, in accordance with the present disclosure.

### DETAILED DESCRIPTION

In the following detailed description, reference is made to the accompanying drawings that form a part hereof, and in which is shown by way of illustration, specific examples in which the invention may be practiced. These examples are described in sufficient detail to enable those skilled in the art to practice the invention, and it is to be understood that other examples may be utilized. It is also to be understood that structural, procedural, chemical and system changes can be made without departing from the spirit and scope of the present invention. The following detailed description is, therefore, not to be taken in a limiting sense, and the scope of the present invention is defined by the appended claims and their equivalents.

The present disclosure describes, among other things, geothermal energy recovery systems and methods using a non-water based fluid, such as a carbon dioxide (CO₂) based fluid, for the recovery of geothermal energy. The geothermal energy recovery systems and methods can include aspects of the example systems and methods disclosed in U.S. Pat. No. 8,316,955 to Saar, et al., entitled “CARBON DIOXIDE-BASED GEOTHERMAL ENERGY GENERATION SYSTEMS AND METHODS RELATED THERETO,” U.S. Pat. No. 8,991,510 to Saar et al., entitled “CARBON DIOXIDE-BASED GEOTHERMAL ENERGY GENERATION SYSTEMS AND METHODS RELATED THERETO,” and U.S. Pat. No. 9,869,167 to Randolph, entitled “CARBON DIOXIDE-BASED GEOTHERMAL ENERGY GENERATION SYSTEMS AND METHODS RELATED THERETO,” all of which are hereby incorporated by reference herein in their entireties.

The present disclosure describes injecting a non-water based working fluid into a subterranean reservoir, such as a geothermal heat recovery reservoir or a sequestration reservoir, as an example of an overall application for which the feed systems and methods of the present disclosure can be used. However, the systems and methods of the present disclosure are not limited to injecting the working fluid into a subterranean reservoir. The geothermal energy recovery systems and methods are provided merely as examples of the many possible overall systems and applications for which the feed systems and methods of the present disclosure can be used. Those having skill in the art will appreciate that the systems and methods described herein can be used for other applications, such as for any application wherein the particular non-water based working fluid being used, e.g., supercritical carbon dioxide, is a feedstock or a working fluid and/or wherein the material of the fluid is loaded into or onto another structure, apparatus, or system.

### Definitions

The terms “subterranean” or “subsurface” or “underground,” as used herein, can refer to locations and/or geological formations beneath the Earth's surface.

The term “rock,” as used herein, can refer to a relatively hard, naturally formed mineral, collection of minerals, or petrified matter. A collection of rocks is commonly referred to as a “rock formation.” Various types of rocks have been identified on Earth, to include, for example, igneous, metamorphic, sedimentary, and the like. A rock can erode or be subject to mass wasting to become sediment and/or soil proximate to or at a distance of many miles from its original location.

The term “sediment,” as used herein, can refer to a granular material eroded by forces of nature, but not yet to the point of becoming “soil.” Sediment may be found on or within the Earth's crust. A collection of sediments is commonly referred to as a “sediment formation.” Sediment is commonly unconsolidated, although “partially consolidated sediments” are often referred to simply as “sediments” and are therefore considered to be included within the definition of sediment.

The term “soil,” as used herein, can refer to a granular material comprising a biologically active, porous medium. Soil is found on, or as part of, the uppermost layer of the Earth's crust and evolves through weathering of solid materials, such as consolidated rocks, sediments, glacial tills, volcanic ash, and organic matter. Although often used interchangeably with the term “dirt,” dirt is technically not biologically active.

The term “fluid,” as used herein, can refer to a liquid, gas, or combination thereof, or a fluid that exists above the critical point, e.g., a supercritical fluid. A fluid is capable of flowing, expanding, and accommodating a shape of its physical surroundings. A fluid can comprise a native fluid, a working fluid, or combinations thereof. Examples of fluid include, for example, air, water, brine (i.e., salty water), hydrocarbon, CO₂, magma, noble gases, or any combination thereof.

The term “native fluid,” as used herein, can refer to a fluid which is resident in a rock formation or sediment formation prior to the implementation of the systems or methods of the present disclosure. A native fluid includes, but is not limited to, water, saline water, oil, natural gas, hydrocarbons (e.g., methane, natural gas, oil), and combinations thereof. Carbon dioxide can also be previously present in the rock or sediment formation and thus constitute a native fluid in this case.

The term “working fluid,” as used herein, can refer to a fluid which is not native to a rock formation or sediment formation and that is used by the systems or methods of the present disclosure for sonic purpose. A working fluid can undergo a phase change from a gas to a liquid (energy source), a liquid to gas (refrigerant), or can become part of a solution (e.g., by dissolving into a native fluid). A “working fluid” in a machine or in a closed loop system can be the heated and/or pressurized gas or liquid that is used for operation of the machine or system, such as by actuating the machine or for transferring energy to or from the system. Water is used as a working fluid in conventional (e.g., water-based) heat engine systems.

The term “non-water based working fluid” refers to a working fluid that is not predominantly water, i.e., to a fluid composition that is less than 50 wt. % water, and in particular that is substantially less than 50 wt. % water, such as 10 wt. % water or less, e.g., 5 wt. % water or less, 4 wt. % water or less, 3 wt. % water or less, 2 wt. % or less, 1 wt. % or less, 0.5 wt. % or less, or 0.1 wt. % or less. Examples of materials that can form the non-water portion of a non-water based working fluid can include, but are not limited to, ammonia, sulfur dioxide, carbon dioxide, and non-halogenated hydrocarbons such as methane. A working fluid can include a fluid in a supercritical state. Different working fluids can have different thermodynamic and fluid-dynamic properties, resulting in different power conversion efficiencies.

In some examples, the “non-water based working fluid” will be a carbon dioxide-based working fluid, also referred to as a “CO₂-based working fluid” or simply a “CO₂ working fluid” for brevity. As used herein, the terms “carbon dioxide-based” or “CO₂-based,” e.g., when referring to a “carbon dioxide-based working fluid,” a “CO₂-based stream,” and the like, refers to a process stream that is predominantly carbon dioxide (CO₂), for example 50 wt. % or more CO₂, and in particular substantially more than 50 wt. % CO₂, 75 wt. % or more CO₂, 80 wt. % or more CO₂, 85 wt. % or more CO₂, 90 wt. % or more CO₂, 95 wt. % or more CO₂, 96 wt. % or more CO₂, 97 wt .% or more CO₂ or more, 98 wt. % or more CO₂, 99 wt. % or more CO₂, 99.5 wt. % CO₂ or more, or 99.9 wt. % or more CO₂.

The term “CO₂-based plume” (or the shortened form “CO₂ plume”) as used herein, can refer to a large-scale (e.g., meters to several kilometers to tens of kilometers across) formation of a CO₂-based fluid present within subsurface pore spaces in a subterraneous reservoir. Within a CO₂-based plume, a significant percentage of fluid in the plume formation is CO₂. The CO₂-based plume can include other fluids, such as native methane or other hydrocarbons, which can be collected and carried by the CO₂-based plume as it travels through a reservoir. For example, a CO₂-based plume can include a substantial percentage (e.g., as much as 20 wt. %) methane that has been desorbed from a saline aquifer (as described in more detail below). A CO₂-based plume can also include a substantial portion of native hydrocarbons (e.g., up to 90 wt. % hydrocarbons or more) and can still be considered a “CO₂-based plume” within the meaning of the present disclosure. A CO₂-based plume can contain a substantial portion, e.g., as much as 70% by volume, or more, of a native fluid such as brine or hydrocarbons extracted from a reservoir. The brine or other native fluid can be immobile or only minimally mobile and, therefore, generally considered in the art to be residually trapped.

The term “reservoir” or “storage rock formation” or “storage sediment formation,” as used herein, can refer to a formation comprising one or more of rock, sediment, and soil that can be capable of receiving and storing an amount of fluid substantially “permanently” as that term is understood in the geological arts.

The term “geothermal heat flow,” as used herein, can refer to any kind of heat transfer in the subsurface and can include one or more of conductive heat transfer, advective heat transfer (also referred to as convective heat transfer), and radiative heat transfer (although radiative heat transfer can typically be negligible in the subsurface). A “low” heat flow generally can be considered to be less than about 50 milliwatts per square meter. A “moderate” heat flow generally can be considered to be at least about 50 to about 80 milliwatts per square meter. A “high” heat flow generally can be considered to be greater than 80 milliwatts per square meter.

The term “injection well,” as used herein, can refer to a well or borehole, which can be cased (e.g., lined) or uncased, and which can contain one or more pipes through which a fluid can flow (typically in a downward direction) for purposes of releasing that fluid into the subsurface at some depth. Multiple injection wells, e.g., two or more, for supplying the working fluid to one or more injection areas within a reservoir are also included within this definition.

The term “production well,” as used herein, can refer to a well or borehole, which can be cased (e.g., lined) or uncased, and which can contain one or more pipes through which a fluid can flow (typically in an upward direction) for purposes of bringing fluids up from the subsurface up to the Earth's surface or near the surface. A production well can exist in the same borehole as an injection well. Multiple production wells, e.g., two or more, for drawing fluid from one or more different locations within the reservoir, i.e., to draw fluid from one or more different areas of the plume, are also included within this definition.

### Geothermal Energy Systems

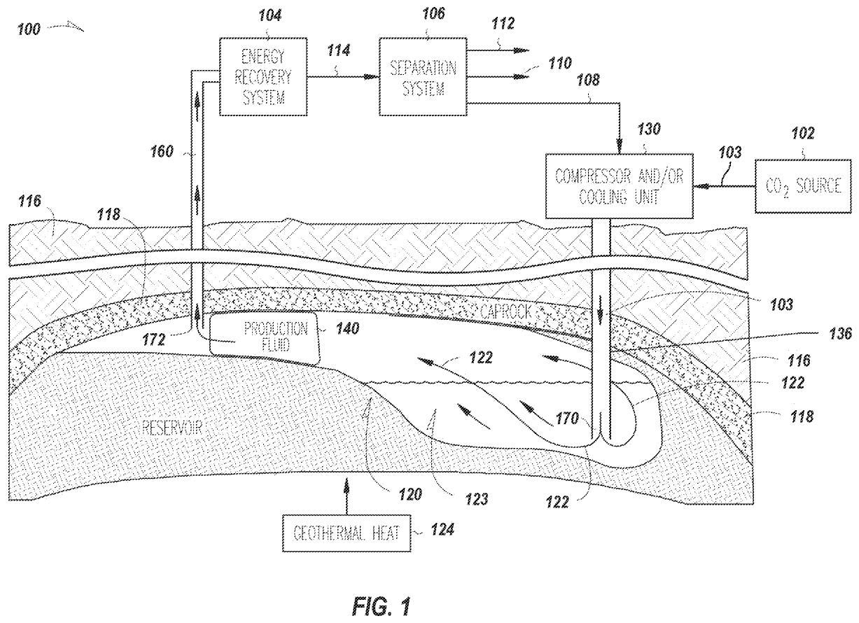

FIGS. 1-4 show examples of systems for the recovery of geothermal energy from a reservoir 120 and for the generation of one or more other types of energy using the captured geothermal energy. FIGS. 1-4 show examples of systems 100, 200, 300, and 400 for capturing geothermal energy with a non-water based working fluid. The inventors have found that a carbon dioxide (CO₂) based working fluid is particularly useful for geothermal energy recovery. Therefore, in the descriptions of FIGS. 1-4, the “non-water based working fluid” will be specifically referred to as “the CO₂-based working fluid,” “the CO₂ working fluid,” or simply “the working fluid” for the sake of brevity. Those having ordinary skill in the art will appreciate that the non-water based working fluid can include other components in addition to or in place of CO₂, including, but not limited to, ammonia (NH₃), hydrogen sulfide (H₂S), carbon monoxide (CO), nitrogen (N₂), sulfur dioxide (SO₂), or non-halogenated hydrocarbons such as methane (CH₄), or combinations thereof.

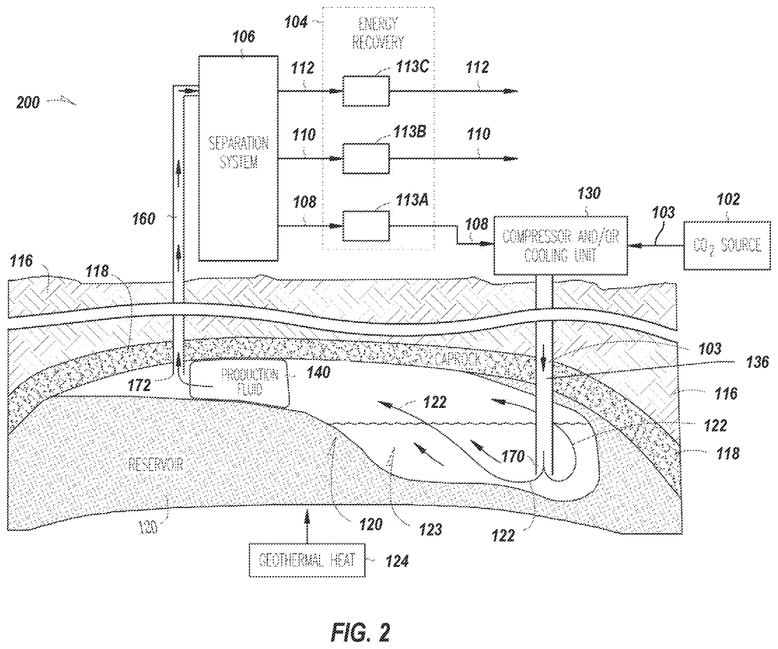

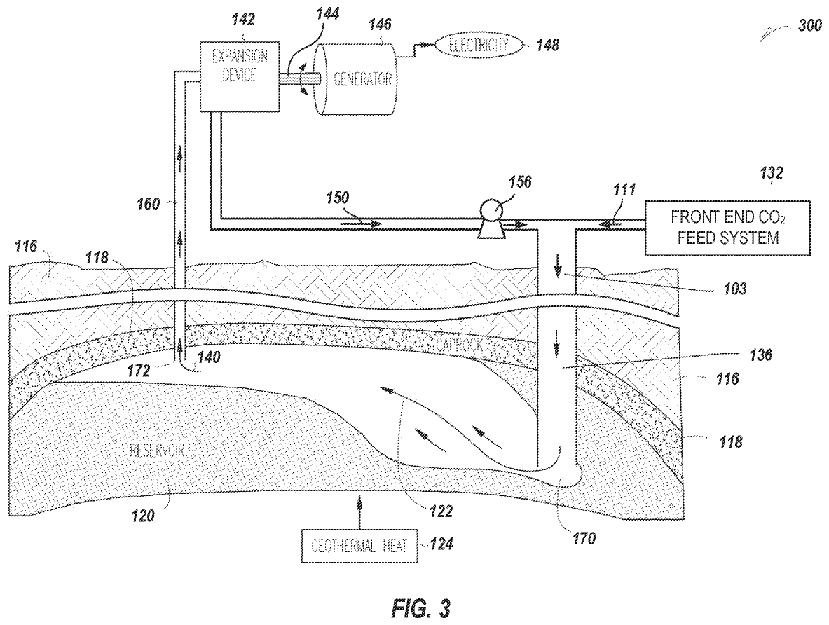

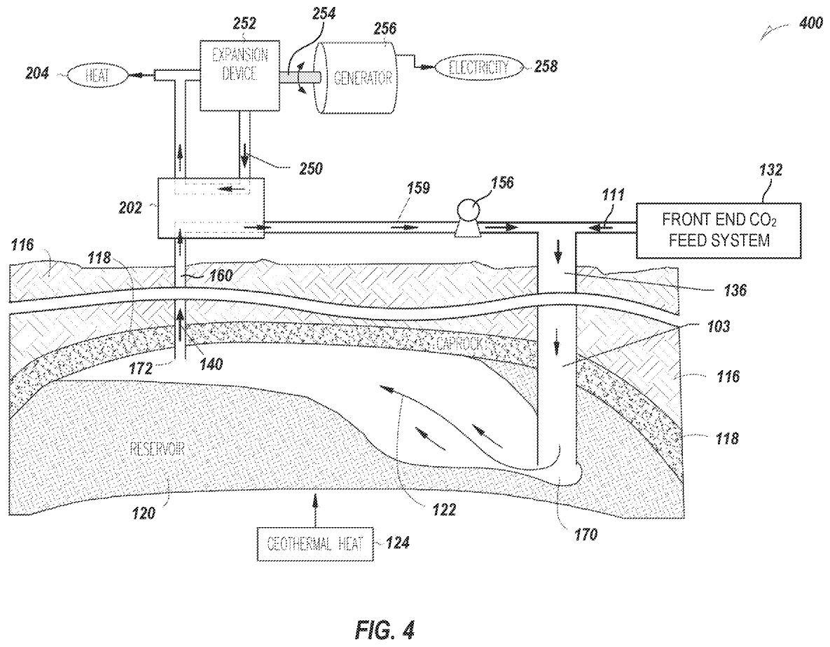

The systems 100 and 200 in FIGS. 1 and 2 include two examples of generic energy recovery systems for converting the geothermal energy to another form of energy, e.g., to electricity, heat, or a combination thereof. FIGS. 3 and 4 show more specific examples of systems 300, 400, and in particular show additional details of example energy recovery systems configured to use the geothermal heat energy captured by the CO₂-based working fluid to generate energy, such as electricity, heat, or a combination thereof. Structures and portions of the systems shown in FIGS. 1-4 that are the same or substantially the same are given the same reference number and are described, where possible, by a common description. Those having skill in the art will appreciate that the energy recovery system portion of the overall system can be different from the examples shown in FIGS. 1-4.

In an example, a CO₂-based working fluid 103 is provided by a CO₂ source 102, such as a power plant, an industrial plant, another production facility, or an underground source. The CO₂ source 102 can be provided from an air-capture source or any other source. The carbon dioxide portion of the CO₂-based working fluid 103 can be in liquid form, gaseous form, supercritical form, or a mixture of two or more forms of CO₂. The CO₂-based working fluid 103 can include one or more components in addition to or in place of the CO₂, such as one or more of NH₃, H₂S, CH₄, CO, N₂, or SO₂. In an example, the carbon dioxide portion of the CO₂-based working fluid 103 that is to be injected into the reservoir 120 is supercritical CO₂. Supercritical carbon dioxide has an increased density, as compared with other working fluids, including gaseous carbon dioxide, such that a greater amount can be stored in a smaller volume, thus increasing system efficiency. Additionally, supercritical carbon dioxide has favorable chemical properties and interaction characteristics with water, such as saline water. Supercritical carbon dioxide can also be used in colder conditions since it has a very low freezing point of about −55° C. (depending on the pressure). As such, a carbon dioxide-based system can be used in temperatures much lower than 0° C., such as down to −10° C. or −20° C. or −30° C. or below, down to about −55° C., including any range there between. A larger temperature differential between the heat sink (atmosphere or ambient air) and the heat source (the geothermal energy 124 in the reservoir 120), also increases the overall efficiency of the system.

In an example, each system 100, 200, 300, and 400 is located at a site (i.e., in a position) configured to provide access to a target formation that includes the reservoir 120. The target formation may include one or both of a top layer 116 located above at least a portion of the reservoir 120, and a caprock 118 located above at least a portion of the reservoir 120 and below at least a portion of the top layer 116.

If present, the top layer 116 can include any number of layers and types of natural deposits and/or formations. For example, the top layer 116 can contain or cover one or more features such as a reservoir (e.g., the reservoir 120) or caprock (e.g., the caprock 118) having the features as described herein. The top layer 116 can include one or more layers of sediment and/or soil of varying depths, and additionally or alternatively any type of rock, including rocks or sediments in layers, rock or sediment formations, and the like, or any combinations thereof. In an example, the top layer 116 additionally or alternatively comprises a top layer or layers of sediment and/or soil of varying depths. The permeability and/or porosity of the top layer 116 may vary widely, as long as drilling can be performed to insert the injection well 136 and production well 160. In an example, the top layer 116 can have a wide range of depths (i.e., “thickness”) sufficient to ensure working fluid introduced into the reservoir 120 remains in the desired state, such as a supercritical state. In an example, the depth of the top layer 116 is at least 100 meters (m) or more, up to one (1) kilometer (km), further including more than one (1) km, such as up to three (3) km, four (4) km, five (5) km, or more, such as up to 10 km or over 15 km including any range between and including any combination of the values listed above, such as from about one (1) km to about, five (5) km, below the Earth's surface (i.e., below or within a given topography in an area, which may or may not be exposed to the atmosphere). However, the target formation is not limited to any particular depth for the top layer 116.

If present, the caprock 118 can be a geologic feature overlying at least a portion of the reservoir 120. In an example, the caprock 118 has a very low permeability, i.e., in the nano-Darcy range (10⁻³ millidarcies or less). A low permeability allows the caprock 118 to essentially function as a barrier for fluid contained in the reservoir 120 below. Permeability may also be dependent, in part, on the depth (i.e., thickness) of the caprock 118, as well as the depth of the top layer 116 above. The porosity of the caprock 118 can vary widely. As is known in the art, even if a rock is highly porous, if voids within the rock are not interconnected, fluids within the closed, isolated pores cannot move. In other examples, the caprock 118 may have a permeability that does not prevent or inhibit fluid leakage from the reservoir 120, but rather containment of the fluid or fluids may be because the reservoir 120 itself comprises a rock formation that has a very low vertical permeability (i.e., the fluid cannot flow upward from the reservoir 12 except through the production well 160), while being sufficiently laterally permeable and porous so the fluid or fluids can readily flow across the reservoir 120, e.g., from the injection well 136 to the production well 160.

The thickness of the caprock 118 can vary but is typically substantially less than the thickness of the top layer 116. In an example, the top layer 116 has a thickness on the order of 10, or 10 to 100, up to 1000 times the thickness of the caprock 118, further including any range therebetween, although the systems 100, 200, 300, and 400 are not limited to a caprock 118 having this thickness or even to a reservoir having a caprock at all. In an example, the thickness of the caprock 118 can vary from about one (1) cm up to about 1000 m or more, such as between about five (5) cm and 1000 m, such as between about one (1) m and about 100 m. In an example, the caprock 118 represents more than one caprock layer, such that multiple caprocks are present which partially or completely cover one another and may act jointly as a caprock 118 to prevent or reduce upward leakage of the working fluid from the reservoir 120.

In an example, the reservoir 120 comprises one or more natural underground rock reservoirs capable of containing fluids while still allowing relatively free flow of fluid within the reservoir 120 in at least one direction. The caprock 118 and the reservoir 120 can be made up of a variety of rock types, including, but not limited to: igneous rock; metamorphic rock; limestone; sedimentary rock; crystalline rock; and combinations thereof. In an example, the reservoir 120 is a previously created manmade reservoir or a portion of a previously created manmade reservoir, such as, for example, shale formations remaining from shale fracturing for hydrocarbon removal. In an example, the reservoir 120 is also capable of storing carbon dioxide on a substantially “permanent” basis, e.g., so that the reservoir 120 can be considered as a “sequestration reservoir.” as these terms are understood in the art.

In an example, the natural temperature of the reservoir 120 is at least about 90° C., although the systems 100, 200, 300, and 400 are not so limited. In an example, natural temperatures below 90° C., such as down to 80° C. or 70° C., further including down to 30° C., including any range there between, are present. Natural temperatures greater than 90° C. may also be present, with the highest temperature limited only by the magnitude of the geothermal heat flow 124 provided and the ability of the reservoir 120 to capture and retain the geothermal heat 124. In some examples, temperatures greater than about 300° C. may be present in the reservoir 120.

As noted above, the CO₂-based working fluid 103 is delivered to an injection well 136, wherein the CO₂-based working fluid 103 flows in a substantially downward direction bellow the Earth's surface until it reaches an injection well opening 170, through which the CO₂-based working fluid 103 is released into the reservoir 120.

In an example, the CO₂-based working fluid 103 permeates the reservoir 120 and forms a CO₂-based plume 122 (which may also be referred to simply as “the CO₂ plume 122” for brevity, even if the plume 122 is not entirely CO₂). In an example, the CO₂-based plume 122 is exposed to the temperatures of the reservoir 120, which are higher than the temperature of the CO₂-based working fluid 103 that is fed into the injection well 136. The CO₂-based working fluid 103 absorbs heat from the reservoir 120, which can result in an upwardly migrating CO₂-based plume 122 within the reservoir 120. In an example, the CO₂-based plume 122 can be laterally advected due to non-zero groundwater flow velocities within the reservoir 120. In an example, lateral migration occurs additionally or alternatively due to the CO₂-based plume 122 spreading, as additional CO₂-based working fluid 103 exits the injection well opening 170.

In an example, the CO₂-based plume 122 can incorporate one or more components of a native fluid 123, which can be in the form of the one or more components being at least partially dissolved in the CO₂-based plume 122 or included as individual bubbles or fluid pockets dispersed throughout the CO₂-based plume 122.

The CO₂-based plume 122, which may or may not include one or more components of the native fluid 123, can migrate, be transported, flow, and/or spread towards the production well 160, where it enters a production well reservoir opening 172 and flows into the production well 160 as a production fluid 140. When the production fluid 140 reaches the production well reservoir opening 172, it can be transported via a pressure differential and/or buoyantly move in a generally upwardly direction towards the Earth's surface. As described in more detail below, the production fluids 140 can be fed into an energy recovery apparatus that can convert energy in the production fluid 140 to another form of energy, such as electricity, heat, or a combination thereof, such as those described below for the systems of FIGS. 1-4.

In an example, the CO₂-based working fluid 103 can interact with a native fluid 123 that is within the reservoir 120. For example, the native fluid 123 can comprise one or more hydrocarbons and the CO₂-based working fluid 103 can interact with the one or more hydrocarbons. In another example, the reservoir 120 comprises an aquifer, e.g., a saline aquifer, or a saline or water-filled rock formation such that the native fluid 123 can include a saline (also referred to as “a brine solution” or simply “brine”). In an example, at least a portion of the native fluid 123, such as a portion of the one or more hydrocarbons or the brine, can combine with the original CO₂-based working fluid 103 to form at least one production fluid 140. In another example, the reservoir 120 contains little to no native fluid or the native fluid 123 that is present does not interact and/or does not combine with the CO₂-based working fluid 103 to form the production fluid 140 Rather, the production fluid 140 may only comprise the CO₂-based working fluid 103 that has absorbed geothermal heat 124 and been heated to a higher temperature.

As the production fluid 140 moves through the reservoir 120, it can become heated by geothermal heat 124 that is present in or is supplied to the reservoir 120. The geothermal heat 124 can raise the temperature of the production fluid 140, raise the pressure of the production fluid 140, or both, and in particular raise the temperature of the CO₂-based working fluid 103, raise the pressure of the CO₂-based working fluid 103, or both, within the production fluid 140 compared to the temperature of the CO₂-based working fluid 103 as it exits the injection well opening 170. The heated production fluid 140 can enter the production well 160 such as through a production well opening 172. The production fluid 140 can be returned to the surface through the production well 160.

In the generic systems 100 and 200 of FIGS. 1 and 2, energy can be recovered from the production fluid 140 in an energy recovery system 104A, 104B. The energy recovery system 104 can include any apparatus or system configured to recover energy from a portion or all of the production fluid 140. For example, the energy recovery system 104 can include any or all of the components described above for the electricity-generating system or heat energy recovery system described below with respect to FIGS. 3 and 4.

The generic systems 100 and 200 of FIGS. 1 and 2 can also include a separation system 106 for separating one or more components from the production fluid 140. In particular, the separation system 106 may be included if there is a native fluid 123, and one or more components of the native fluid 123, such as a brine or one or more hydrocarbons, are included in the production fluid 140.

The separation system 106 can include any separation operation that is known in the art for separating components from the production fluid 140. For example, the separation system 106 can include one or more operation units for separating CO₂, from hydrocarbons, from other native fluids such as water or brine, or from injected fluids such as a working fluid that comprises a substantial amount of water. The separation system 106 can also include one or more separation operation units for separating hydrocarbons from other native fluids such as water or brine. Examples of separation operation units that can be used for the separation of CO₂, hydrocarbons, or other native fluids, include, but are not limited to: distillation units, such as one or more distillation columns; absorption units, such as one or more absorption columns; chromatography units; density separation units, such as centrifuges, cyclone separators, decanters and the like; crystallization or recrystallization units; electrophoresis units; evaporation or drying units; extraction units, such as leaching, liquid-liquid extraction, or solid-phase extraction; stripping units; and the like. In an example, shown in FIGS. 1 and 2, the separation system 106 is configured to separate the production fluid 140 into a CO₂-based stream 108, a hydrocarbon stream 110, and a brine stream 112 (which can include other injected fluids such as a water-containing working fluid).

Each stream 108, 110, 112 can be further treated or processed after separation. For example, the CO₂-based stream 108 can be fed back into the reservoir 120, such as by feeding the CO₂-based stream 108 into the compressor and/or a cooling unit 130 for reinjection back into the injection well 136, as shown in FIGS. 1 and 2. The hydrocarbon stream 110 can be delivered to a refining system to further refine the one or more hydrocarbons into various petroleum products. The brine solution stream 112 can be sold as a product, further treated, delivered back into the reservoir 120, released at the land surface or injected into other subsurface formations, or can be disposed of otherwise.

The separation system 106 can be configured to be operated before, i.e., upstream of, the energy recovery system 104, or the separation system 106 can be operated after, i.e., downstream of, the energy recovery system 104. FIG. 1 shows an example system 100 with the separation system 106 being positioned downstream of the energy recovery system 104 so that energy, for example in the form of heat or electricity, can be recovered from the production fluid 140 before separating the production fluid 140 into separate components. In such a system, the energy recovery system 104 can be configured to recover heat from the production fluid 140 in its entirety. After energy is recovered from the production fluid 140, the fluid can exit the energy recovery system 104 as one or more fluids 114 that are in a cooled, and possibly expanded (e.g., lower pressure), state. The cooled fluid 114 can be fed into the separation system 106.

In the example system 200 of FIG. 2, the separation system 106 is positioned upstream of the energy recovery system 104 so that the CO₂-based stream 108, the hydrocarbon stream 110, and the brine stream 112 can be separated before energy is recovered from each stream in the energy recovery system 104. In such a configuration, the energy recovery system 104 can include a separate dedicated energy recovery device or devices for each stream 108, 110, 112, such as a first energy recovery device or devices 113A configured to recover energy from the CO₂-based stream 108, a second energy recovery device or devices 113B configured to recover energy from the hydrocarbon stream 110, and a third energy recovery device or devices 113C configured to recover energy from the brine solution stream 112.

Alternatively, the production fluid 140 can include a :large percentage of one component, such as up to about 99 wt% hydrocarbons, so that dedicated energy recovery device or devices for each of the remaining components (that, make up part of the remaining 1 wt. %) may not be practical. In such a situation, the separation system 106 can be configured to separate out only the component with the large mass percentage, such as the hydrocarbons, and leave the other components in a combined stream. Also, the energy recovery system 104 can include only a first energy recovery device or devices configured to recover energy from the large-percentage component, and a second energy recovery device or devices for the other components. If the mass percentage of the other components is small enough, it may even be desirable to only recover energy from the large-percentage component, and to forgo energy recovery from the other components.

In the examples shown in FIGS. 1 and 2, each set of the one or more dedicated energy recovery devices, such as one or more expansion devices and generators (e.g., turbine-generator combinations) or binary systems with heat exchangers, can be used to recover energy from the CO₂-based stream 108, the hydrocarbon stream 110, and the brine solution stream 112. Because each stream 108, 110, 112 can have its own dedicated energy recovery device or devices 113A, 113B, 113C, each dedicated energy recovery device or devices 113A, 113B, 113C can be configured for the specific stream 108, 110, 112.

In the energy recovery system 100 in which the fluid separation system 106 is downstream of (e.g., after) the energy recovery system 104, heat or pressure energy are not lost in the fluid separation system 106 prior to energy recovery in the energy recovery system 104. Thus, it can be possible for more energy in the production fluid 140 to be converted into electricity, heat, or a combination of electricity and heat for direct use. However, in this system 100, the production fluid stream 140 can be less likely to be suitable for use directly in an expansion device. Rather, the production fluid 140 may be required to be sent through a heat exchanger, providing thermal energy to a secondary working fluid that in turn is sent through an expansion device in what is generally referred to as a “binary system.” Examples of binary systems include, but are not limited to, Organic Rankine Cycle (ORC) and Kalina systems. The use of a heat exchanger and a binary system can decrease overall efficiency in conversion of energy from the production fluid 14( )to electricity or heat, or both, for direct use.

In contrast, in the system 200 in which the separation system 106 is upstream of (e.g., before) the energy recovery system 104, each fluid stream 108, 110, 112 can be sent through an energy recovery apparatus 113A, 113B, 113C specifically designed for the composition of each component of the separated production fluid 140, such as the first energy recovery device or devices 113A for the CO₂-based stream 108, the second energy recovery device or devices 113B for the hydrocarbon stream 110, and the third energy recovery device or devices 113C for the brine or water stream 112. Thus, the energy recovery efficiency for each fluid stream 108, 110, 112 can be optimized, which may be limited in the case of separation downstream of (e.g., after) energy recovery (as described above). In an example, the energy recovery device or devices 113C for cases where the hydrocarbon stream 110 that is liquid or primarily liquid and the brine or water stream 112 can be an Organic Rankine Cycle or other binary system, potentially with different secondary working fluids. However, for the CO₂-based stream 108 and cases where the hydrocarbon stream 110 is gaseous or primarily gaseous, the energy recovery apparatus can be a direct turbine because the lower density of these gaseous or supercritical fluids can provide much more energy in the form of electricity than higher density fluids in liquid phase when decreasing between the same pressure levels. Passing a low-density fluid through a direct turbine followed by a cooling apparatus generally can produce more electricity than extracting thermal energy to operate an Organic Rankine Cycle or other binary system, and then decreasing the pressure through a valve or turbine, when operating between the same inlet and exit conditions.

FIGS. 3 and 4 show other example systems 300 and 400, respectively, for recovering geothermal heat captured by the CO₂-based working fluid 103 and using it to generate electricity, heat, or a combination thereof. Both the system 300 of FIG. 3 and the system 400 of FIG. 4 include a front end CO₂ feed system 132 (also referred to herein as “the CO₂ feed system 132”) that is configured to supply a compressed CO₂-based stream 111 to system 300, 400, which in turn is injected into the injection well 136 as the CO₂-based working fluid 103. In preferred examples, the CO₂ feed system 132 is configured to supply the compressed CO₂-based stream 111 as a supercritical CO₂.

In an example, the compressed CO₂-based stream 111 supplied by the CO₂ feed system 132 comprises supercritical CO₂ with a temperature of at least about 35° C. (at least about 100° F.) and/or no more than about 95° C. (no more than about 200° F.), such as from about 35° C. (about 100° F.) to about 65° C. (about 150° F.), for example from about 50° C. (about 120° F.) to about 65° C. (about 150° F.) and with a pressure of at least about 8.3 megapascals (MPa) (at least about 1200 pounds per square inch absolute (psia)) and/or no more than about 13.8 MPa (no more than about 2000 psia), such as from about 8.3 MPa (1200 psia) to about 12.4 MPa (about 1800 psia), for example from about 10.3 MPa (about 1500 psia) to about 12.4 MPa (about 1800 psia). The compressed CO₂-based stream 111 received from the CO₂ feed system 132 can be fed directly into the injection well 136 such that the compressed CO₂-based stream 111 from the CO₂ feed system 132 makes up at least a portion of the CO₂-based working fluid 103 with little or no modification.

In the system 300 shown in FIG. 3, the production fluid 140 is fed into an expansion device 142 after being produced from the production well 160. The flow of the production fluid 140 through the expansion device 142 produces shaft power 144 which can be provided to a generator 146 to produce electricity 148. The expansion device 142 can comprise any suitable type of expansion device 142 known in the art, including any type of turbine, although the systems described herein are not limited to a turbine. In an example, the expansion device 142 can include, but is not limited to: a piston-cylinder device; or a scroll, screw, or rotary compressor designed to run in reverse as engines.

The production fluid 140 exits the expansion device 142 as a warm CO₂-based stream 150. In an example, the warm CO₂-based stream 150 is primarily supercritical CO₂ having a temperature of at least about 30° C. (at least about 90° F.) and/or no more than about 100° C. (no more than about 215° F.), such as from about 35° C. (about 100° F.) to about 95° C. (about 200° F.), for example from about 50° C. (about 120° F.) to about 80° C. (about 175° F.), and a pressure of at least about 7.5 MPa (at least about 1100 psia) and/or no more than about 17.2 MPa (no more than about 2500 psia), such as from about 8.3 MPa (about 1200 psia) to about 16.5 MPa (2400 psia), for example from about 8.3 MPa (1200 psia) to about 15.9 MPA (2300 psia), or from about 9 MPa (1300 psia) to about 15.2 MPa (about 2200 psia). The CO₂-based stream 150 can be injected directly into the injection well 136 to provide a portion of the working fluid 103 that is injected into the reservoir 120. In an example, the CO₂-based stream 150 can be fed through an optional pump 156 before being fed into the injection well 136.

In an example, a portion of the shaft power 144 produced by the one or more expansion devices 142 can be used to drive one or more components of the system 100 instead of or in addition to producing electricity (not shown). For example, a portion of the shaft power 144 can be used to drive the compressor or pump 156 to re-pressurize the CO₂-based stream 150 before it is injected back into the injection well 136.

In another example system 400, shown in FIG. 4, the heated production fluid 140 passes through a heat exchanger 202 where it warms a secondary working fluid 250 also cycling through the heat exchanger 202. Heat 204 can be released from at least a portion of the heated secondary working fluid 250 and can be used in any direct use application and/or as a ground-source heat pump, using components well known in the art. In an example, a portion of the heated secondary working fluid 250 can be fed into an expansion device 252, which can be similar or identical to the expansion device 142 described above, except that the expansion device 142 is a direct expansion device while the expansion device 252 is part of a binary power cycle. Like the expansion device 142, the expansion device 252 produces shaft power 256 that can be used to drive a generator 256 to produce electricity 258. The production fluid 140 exits the heat exchanger 202 as a cooled CO₂-based stream 159, which can be a condensed liquid in some examples. The cooled CO₂-based stream 159 can be passed through an optional pump or compressor 156, which can be similar or identical to the pump 156 described above with respect to the system 300. The cooled CO₂-based stream 159 can then injected into the injection well 136 as a portion of the CO₂-based working fluid 103.

### Energy Recapturing Front-End Compressed Carbon Dioxide Feed System

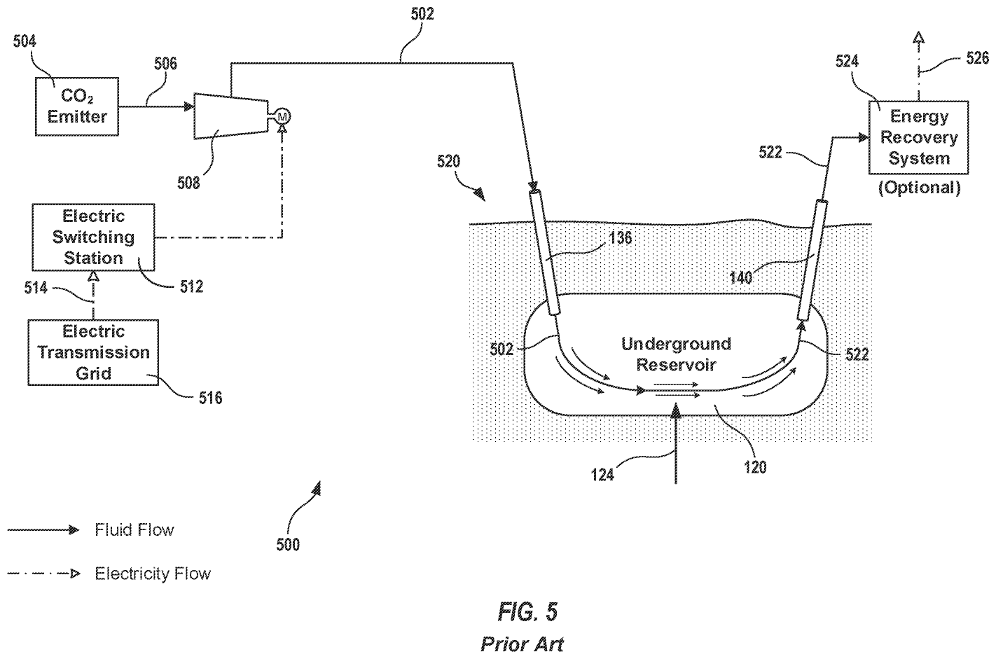

The CO₂ source 102 in the systems 100 and 200 of FIGS. 1 and 2 are depicted as generic process blocks. Similarly, the front-end CO₂ feed system 132 in the systems 300 and 400 of FIGS. 3 and 4 are depicted as generic process blocks. Neither show any specifics regarding the system components that can provide a CO₂-based fluid having the parameters desired as a highly compressed or supercritical working fluid a specified temperature and a specified pressure) for injecting into a reservoir 120 and/or loading into or onto another piece of equipment, such as another processing facility. FIGS. 5-9 show examples of front end CO₂ feed systems that can be used as the CO₂ source 102 in the systems 100 and 200 or as the CO₂ feed system 132 in the systems 300 and 400 of FIGS. 3 and 4.

FIG. 5 shows an example of a conventional system 500 that carp provide a compressed CO₂-based stream 502. In an example, the system 500 includes a CO₂ emitter 504 that provides a CO₂-based feed stream 506. Examples of facilities that could be the CO₂ emitter 504 include but are not limited to: a fossil fuel-burning electrical power plant (e.g., a coal-burning power plant or a natural gas-burning power plant); an ethanol-burning electrical power plant; a biofuel production facility (e.g., an ethanol production plant); any industrial facility that emits a CO₂-based fluid as a byproduct or waste product (e.g., a cement manufacturing plant or a steel manufacturing plant); and the like. In some examples, the CO₂ emitter 504 can be a third-party facility that is willing to have an economic exchange of value to have its emitted CO₂-based byproduct taken away to reduce its carbon footprint, e.g., on the carbon-trading market, which can provide an additional revenue stream to the operator of the systems described herein. In some examples, the CO₂-based feed stream 506 is supplied by a plurality of emitters 504 that combine their CO₂ output to provide the CO₂-based feed stream 506.

As noted above, in some examples the CO₂-based feed stream 506 can be formed, at least in part, from the emissions from one or more production facilities or power generation facilities, e.g., from the burning of one or more fossil fuels or fossil-fuel alternatives. In those examples, the CO₂-based feed stream 506 can include one or more impurities in addition to the primary CO₂ portion of the stream 506, including, but not limited to, carbon monoxide (CO), nitrogen (N₂), unburned hydrocarbons such as methane (CH₄), hydrogen sulfide (H₂S), ammonia (NH₃), or sulfur dioxide (SO₂). In an example, the amount of certain impurities in the CO₂-based feed stream 506 is limited, depending on the application for which the compressed CO₂-based stream 502 is to be used. In examples where the CO₂-based stream 502 is to be used as a working fluid for recovery of geothermal energy from a reservoir 120 and/or if at least a portion of the CO₂-based stream 502 is to be sequestered in the reservoir 120, then the levels of one or more impurities in the CO₂-based feed stream 506 may be limited to one or more of the following impurity specifications: less than 35 mol. % NH₃, preferably 30 mol. % or less NH₃, such as 20 mol % or less NH₃, 10 mol. % or less NH₃, or 5 mol % or less NH₃; limitations to H₂S based on safety standards, such as those provided by the Occupational Safety and Health Administration (“OSHA”) of the United States Federal Government; 10 mol. % or less CH₄, preferably 5 mol. % or less CH₄, still more preferably 1 mol. % or less CH₄, such as 0.5 mol. % or less CH₄, or 0.1 mol. % or less CH₄, or 0.01 mol. % or less CH₄; 10 mol. % or less CO, preferably 5 mol % or less CO, still more preferably 1 mol. % or less CO, such as 0.5 mol. % or less CO, or 0.1 mol. % or less CO, or 0.01 mol % or less CO; 10 mol. % or less N₂, preferably 5 mol. % or less N₂, still more preferably 1 mol. % or less N₂, such as 0.5 mol. % or less N₂, or 0.1 mol %, or less N₂, or 0.01 mol. % or less N₂; less than 20 mol. % SO₂, preferably 10 mol. % or less SO₂, such as 5 mol. % or less SO₂ or 1 mol. % or less SO₂. In examples where the amount of one or more of these impurities within the CO₂-based feed stream 506 are higher than the impurity specifications provided above, then the system 500 can optionally include one or more apparatuses to remove or separate at least a portion of one or more of the impurities to a level that is below the impurity levels specified above.

In most examples, the CO₂-based feed stream 506 is at a relatively low temperature, e.g., from about 4° C. (40° F.) to about 95° C. (200° F.), such as from about 10° C. (about 50° C.) to about 88° C. (about 190° F.), for example from about 15° C. (about 60° F.) to about 82° C. (about 180° F.), such as from about 20° C. (about 68° F.) to about 80° C. (about 175° F.), for example from about 25° C. (about 80° F.) to about 75° C. (about 170° F.), such as from about 30° C. (about 85° F.) to about 70° C. (160° F.), for example from about 35° C. (about 100° F.) to about 65° C. (about 150° E). The CO₂-based feed stream 506 will also often be at a relatively low pressure, such as from about 0.1 MPa (about 15 psia) to about 10.3 MPa (about 1500 psia), for example from about 0.2 MPa (about 30 psia) to about 8.5 MPa (about 1200 psia). Since a compressed CO₂-based stream is the desired output from the front end of the system 500, the CO₂-based feed stream 506 is fed into a compressor 508 to increase the pressure and/or the temperature of the CO₂-based feed stream 506, providing the compressed CO₂-based stream 502. In a preferred example, the compressor 508 compresses and/or heats the CO₂-based feed stream 506 so that the CO₂ component of the compressed CO₂-based stream 502 is supercritical CO₂. A typical example of a stream comprising supercritical CO₂ that may be produced by a conventional compressor 508 is a CO₂-based stream 502 at a temperature of at least about 65° C. (at least about 150° F.) and/or no more than about 205° C. (no more than about 400° F.), such as from about 75° C. (about 165° F.) to about 180° C. (about 355° F.), for example from about 90° C. (about 195° F.) to about 150° C. (about 300° F.), such as from about 95° C. (about 200° F.) to about 120° C. (about 250° F.), and a pressure of at least about 17 MPa (at least about 2500 psia) and/or no more than about 27.6 MPa (no more than about 4000 psia), for example from about 19 MPa (2750 psia) to about 26.2 MPa (3800 psia), such as from about 20.7 MPa (3000 psia) to about 24.1 MPa (about 3500 psia).

Compressing the CO₂-based feed stream 506 is relatively energy intensive, particularly when the compressor 508 is configured to produce a compressed CO₂-based stream 502 that is supercritical CO₂. In an example, shown in FIG. 5, the compressor 508 is powered by electricity 510 delivered from an electric switching station 512. In such an example, the electricity 510 may have been purchased from an electricity-producing utility (also referred to herein simply as the “electric utility”). In an example, electricity 514 is provided to the electric switching station 512 from a wide-area electric transmission grid 516 that is operated and maintained by the electric utility. In another example (not shown), all or a portion of the electricity 510 can be produced by the operator of the compressor 508, either onsite with the compressor 508 or at a remote location, for example with an electricity-producing apparatus, such as a hydrocarbon engine configured to generate electricity.

The cost of the electricity 510 is one of the highest, if not the highest, operating costs for the front-end portion of the system 500. In addition, the electricity cost is subject to the overall energy market such that the cost of the electricity 510 used by the compressor 508 can vary wildly. This can cause the operator's net margin to vary widely depending on the vagaries of the local, national, and global energy markets.

After the compressed CO₂-based stream 502 is provided by the compressor 508, it can be used in any process where a compressed CO₂-based stream is desired. For example, the impressed CO₂-based stream 502 can be fed into an injection well 136 for injection into a subterranean reservoir 120. In some examples, the reservoir 120 can be part of a geothermal energy recovery system 520 wherein the compressed CO₂-based stream 502 can absorb geothermal heat 124, similar to what is described above with respect to FIGS. 1-4. In other words, the compressed CO₂-based stream 502 can be used as the CO₂-based working fluid 103 in the systems 100, 200, 300, or 400 of FIGS. 1-4, or in any other geothermal energy recovery system where a compressed CO₂-based stream is used as the working fluid. In another example, the reservoir 120 can be used as a place to sequester the compressed CO₂-based stream 502 for short term, medium term, long term, or permanent or substantially permanent storage. In other words, the reservoir 120 can be operated as a sequestration reservoir for holding and sequestering the compressed CO₂-based stream 502 in order to reduce the carbon footprint of the CO₂ emitter 504.

In the example of the geothermal energy recovery system 520, the compressed CO₂-based working fluid 502 can flow through the reservoir 120 where it absorbs geothermal energy 124, which heats the compressed CO₂-based working fluid 502 and provides a heated production fluid 522. The production fluid 522 can be returned to the surface via a production well 140, where the production fluid 522 can be fed into an energy recovery system 524. The energy recovery system 524 can convert at least a portion of the geothermal heat energy 124 absorbed by the production fluid 522 into another usable form of energy, such as electricity 526, heat energy (not shown), or a combination thereof. In an example, the electricity 526 which can be used or sold as desired by the operator of the system.

The inventors of the present subject matter have discovered that the compressed CO₂-based stream 502, when compressed by a conventional compressor like the compressor 508, is usually compressed beyond what is necessary for the intended use of the CO₂ -based stream 502. This can be particularly true when it is intended for the CO₂-based stream 502 to be in a supercritical state, such as when the CO₂-based stream 502 is used as the working fluid in the geothermal energy recovery system 520. This can occur because it is extremely difficult, not to mention economically impractical, to design a compressor that can compress the CO₂-based feed stream 506 to the exact temperature and pressure desired for the particular application for which the compressed CO₂-based stream 502 is to be used. The difficulty in designing the compressor 508 is exacerbated by the fact that the composition of the CO₂-based feed stream 506 will vary as processes of the CO₂ emitter or emitters 504 varies. Therefore, the compressor 508 is typically selected as one out of many standardized compressors made by a compressor manufacturer. The compressor 508 is also typically selected so that it imparts more energy than is necessary for the desired state of the CO₂-based stream 502. In the case where the CO₂-based stream 502 as the working fluid in the geothermal energy recovery system 520, this tends to mean that the standard compressor 508 imparts more energy into the CO₂-based stream 502 than is necessary for effective and efficient injection of the compressed CO₂-based 502 into the reservoir 120 for geothermal energy recovery. In other words, the use of the standard compressor 508 results in excess energy being imparted into the CO₂-based stream 502 by the compressor 508 without a corresponding increase in energy capture by the compressed CO₂-based stream 502 in the reservoir 120.

As used herein, the term “excess energy,” when referring to the energy imparted by the compressor 508 into the CO₂-based stream 502 means any energy that is imparted by a compressor onto a CO₂-based stream that is more than is necessary for the CO₂-based stream 502 to be at a specified temperature and pressure selected for the application that the CO₂-based stream 502 is to be used. In examples where the CO₂-based stream is being compressed for geothermal energy recovery or sequestration, the “excess energy” can refer to any energy beyond what is needed so that the the temperature and pressure of the CO₂-based stream being compressed comprises supercritical CO₂ at a specified temperature and pressure. In other words, even if the CO₂-based stream in question were to have the excess energy removed, the CO₂-based stream 502 would still be supercritical.

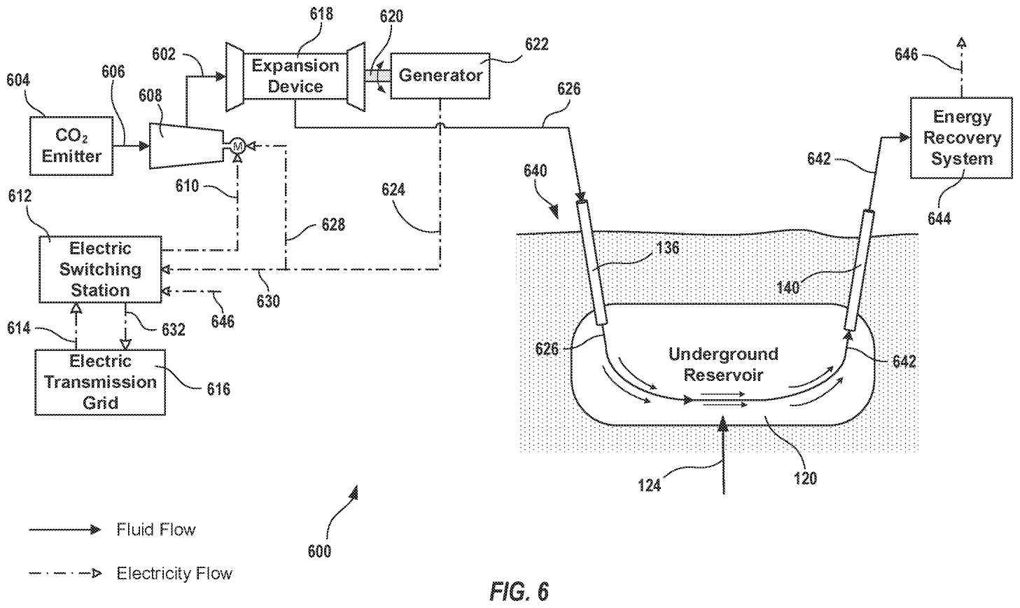

FIGS. 6-9 show other examples of CO₂ feed systems that alleviate the potential waste of excess energy imparted onto a CO₂-based feed stream by a compressor. Specifically, the systems are configured to recapture at least a portion of the excess energy and convert it to another usable form of energy, such as electricity, heat, or both.

Similar to the system 500, the system 600 of FIG, 6 produces a compressed CO₂-based stream 602 by receiving a CO₂-based feed stream 606 from a CO₂ emitter or emitters 604 and compressing the CO₂-based feed stream 606 with a compressor 608. The CO₂ emitter or emitters 604, the CO₂-based feed stream 606, the compressor 608, and the compressed CO₂-base stream 602 can be similar or identical to the CO₂ emitter 504, the CO₂-based feed stream 506, the compressor 508, and the CO₂-based stream 502 from the system 500 of FIG. 5. Also similar to the system 500, the compressor 608 can be at least partially powered by electricity 610, which can be delivered from a local electric switching station 612, which in turn can be powered by electricity 614 from a wide-area electric transmission grid 616. The electricity 610 can also be at least partially produced by the operator of the compressor 608, such as with an onsite electricity-producing apparatus.

However, the system 600 includes additional components to recapture at least a portion of the excess energy that may have been imparted into the compressed CO₂-based stream 602 and convert at least a portion of the recaptured excess energy to electricity. The compressed CO₂-based stream 602 can have parameters that are the same or substantially the same as described above for the compressed CO₂-based stream 502 from the compressor 508 in FIG. 5, e.g., a temperature of at least about 65° C. (at least about 150° F.) and/or no more than about 205° C. (no more than about 400° F.), such as from about 75° C. (about 165° F.) to about 180° C. (about 355° F.), for example from about 90° C. (about 195° F.) to about 150° C. (about 300° F.), such as from about 95° C. (about 200° F.) to about 120° C. (about 250° F.), and a pressure of at least about 17 MPa (at least about 2500 psia) and/or no more than about 27.6 MPa (no more than about 4000 psia), for example from about 19MPa (2750 psia) to about 26.2 MPa (3800 psia), such as from about 20.7 MPa (3000 psia) to about 24.1 MPa (about 3500 psia). As is also noted above, at this temperature and pressure, the CO₂-based stream 602 has more energy than is necessary for the CO₂-based stream 602 to be in the supercritical state. Therefore, the compressed CO₂-based stream 602 can have a substantial amount of excess energy that remains uncaptured if the compressed CO₂-based stream 602 were to be directly injected into the reservoir 120.

In order to recapture at least a portion of the excess energy, the system 600 includes an electricity generating subsystem to convert at least a portion of the excess energy to electricity. In an example, the electricity generating subsystem includes an expansion device 618, such as a turbine, that produces shaft power 620, which in turn can be provided to a generator 622 that converts the shaft power 620 into electricity 624, similar to the expansion device 142 and generator 146 in FIG. 3. A CO₂-based stream 626 that has less energy than the compressed CO₂-based stream 602 is drawn off the expansion device 618, which will be referred to hereinafter as “the de-energized CO₂-based stream 626” for brevity. The de-energized CO₂-based stream 626 has a temperature that is lower than that of the compressed CO₂-based stream 602, a pressure that is lower than that of the compressed CO₂-based stream 602, or both. However, in an example, the expansion device 618 is configured so that the de-energized CO₂-based stream 626 is still in a supercritical state, e.g., so that the expansion device 618 draws off only the amount of the excess energy, or less, so that the de-energized CO₂-based stream 626 is at a specified temperature and pressure. For example, if the compressed CO₂-based stream 602 has a temperature of from about 65° C. (about 150° F.) to about 205° C. (about 400° F.), such as from about 75° C. (about 165° F.) to about 180° C. (about 355° F.), for example from about 90° C. (about 195° F.) to about 150° C. (about 300° F.), such as from about 95° C. (about 200° F.) to about 120° C. (about 250° F.), and a pressure of from about 17 MPa (about 2500 psia) to about 27.6 MPa (about 4000 psia), for example from about 19 MPa (2750 psia) to about 26.2 MPa (3800 psia), such as from about 20.7 MPa (3000 psia) to about 24.1 MPa (about 3500 psia), after exiting the compressor 608, as noted above, than the de-energized CO₂-based stream 626 can have a temperature of from about 35° C. (about 100° F.) to about 100° C. (about 215° F.), such as from about 50° C. (about 120° F.) to about 95° C. (about 200° C.) and a pressure of from about 8.3 MPa (about 1200 psia) to about 24.1 MPa (3500 psia), such as from about 13.8 MPa (about 2000 psia) to about 20.7 MPa (about 3000 psia) which is still supercritical, albeit with less energy than what was originally in the compressed CO₂-based stream 602.

The exact specified temperature and pressure desired for the de-energized CO₂-based stream 626 can depend on the specific application for which the de-energized CO₂-based stream 626 is to be used. For example, if the dc-energized CO₂-based stream 626 is to be used as a working fluid to recover geothermal energy from a reservoir 120, then the specified temperature for the stream 626 can be from about 35° C. (about 100° F.) to about 100° C. (about 215° F.), such as from about 50° C. (about 120° F.) to about 95° C. (about 200° C.) and the specified pressure can be from about 8.3 MPa (about 1200 psia) to about 24.1 MPa (about 3500 psia), such as from about 13.8 MPa (about 2000 psia) to about 20.7 MPa (about 3000 psia). In another example, the de-energized CO₂-based stream 626 can be sequestered in the reservoir 120, in which case it may be desirable for the stream 626 to have a similar temperature compared but a lower pressure than when the fluid is used as a geothermal energy recovery working fluid, for example with a specified temperature of from about 35° C. (about 100° F.) to about 100° C. (about 215° F.), such as from about 50° C. (about 120° F.) to about 95° C. (about 200° C.) and a specified pressure of from about 8.3 MPa (about 1200 psia) to about 20 MPa (about 2900 psia), such as from about 10.3 MPa (about 1500 psia) to about 17.2 MPa (about 2500 psia) In another example, the de-energized CO₂-based stream 626 can be used as the working fluid for an enhanced oil recovery (“EOR”) operation, in which case the de-energized CO₂-based stream 626 can have a slightly lower temperature and pressure than when the fluid 626 is being used for geothermal energy recovery or sequestration, e.g., with a specified temperature of from about 35° C. (about 100° F.) to about 65° C. (about 150° F.), such as from about 50° C. (about 120° F.) to about 60° C. (140° F.) and a specified pressure of from about 8.3 MPa (1200 psia) to about 15 MPa (2200 psia), such as from about 10.3 MPa (1500 psia) to about 12.3 MPa (about 1800 psia).

The electricity 624 produced by the generator 622 can be used to provide at least a portion 628 of the power required by one or more components of the system 600, such as the compressor 608. In some examples, at least a portion 630 of the electricity 624 produced by the generator 622 can be sold by the operator as a byproduct that provides an additional income stream. In the example of the system 600 shown in FIG. 6, the electricity 624 can be split into a first portion 628 and a second portion 630. The first portion 628 of the electricity 624 can be used to provide at least a portion of the power required by the compressor 608 such that less purchased electricity 610 is required. The second portion 630 of the electricity 624 can be sold as a byproduct, such as by sending the portion 630 to the electric switching station 612 where it can be sold back to the transmission grid 616 as sold electricity 632.

The production of the electricity 624 and its use to at least partially power the compressor 608 or as a sold byproduct, or both, can reduce the cost of operation of the system 600 (i.e., by using at least a portion 628 of the generated electricity 624 to run the compressor 608, thereby reducing the amount of purchased electricity 610 required) and/or can provide an additional revenue stream for the operator of the system 600 (i.e., by selling at least a portion 630 of the generated electricity 624, e.g., by selling the portion 630 to the electric transmission grid 616 as sold electricity 632), both of which improve the economics of the system 600 when compared to the conventional system 500 where the excess energy is not recaptured from the compressed CO₂-based stream 502.

The de-energized CO₂-based stream 626 from the expansion device 618 is the output from the front end of the system 600. In other words, the front end of the system 600 supplies the de-energized CO₂-based stream 626 to any process that requires compressed CO₂, and in particular supercritical CO₂. For example, the de-energized CO₂-based stream 626 can be fed into an injection well 136 for injection into a subterranean reservoir 120, e.g., a geothermal heat recovery reservoir as part of a geothermal energy recovery system 640 (as shown in the example of FIG. 6), an oil recovery reservoir from which oil is extracted by enhanced oil recovery (“EOR”), or for sequestration of at least a portion of the CO₂-based stream 626.

In the example of the geothermal energy recovery system 640, the CO₂-based stream 626 can be fed to the reservoir 120 through the injection well 136 where it flows through the reservoir 120 and absorbs geothermal energy 124 in order to provide a heated production fluid 642. The production fluid 642 can be returned to the surface via a production well 140, where the production fluid 642 can be fed into an energy recovery system 644. The energy recovery system 644 can convert at least a portion of the geothermal heat energy 124 absorbed by the production fluid 642 into another usable form of energy, such as electricity 646. In some examples, at least a portion of the electricity 646 produced by the energy recovery system 644 can be sold by the operator, such as by delivering the produced electricity 646 to the electric switching station 612. where it can be sold back to the electric transmission grid 616 as a portion of the sold electricity 632. A portion of the produced electricity 646 can also be used to power the compressor 608 or another component of the system 600 or the energy recovery system 644 (not shown) without varying from the scope of the invention.

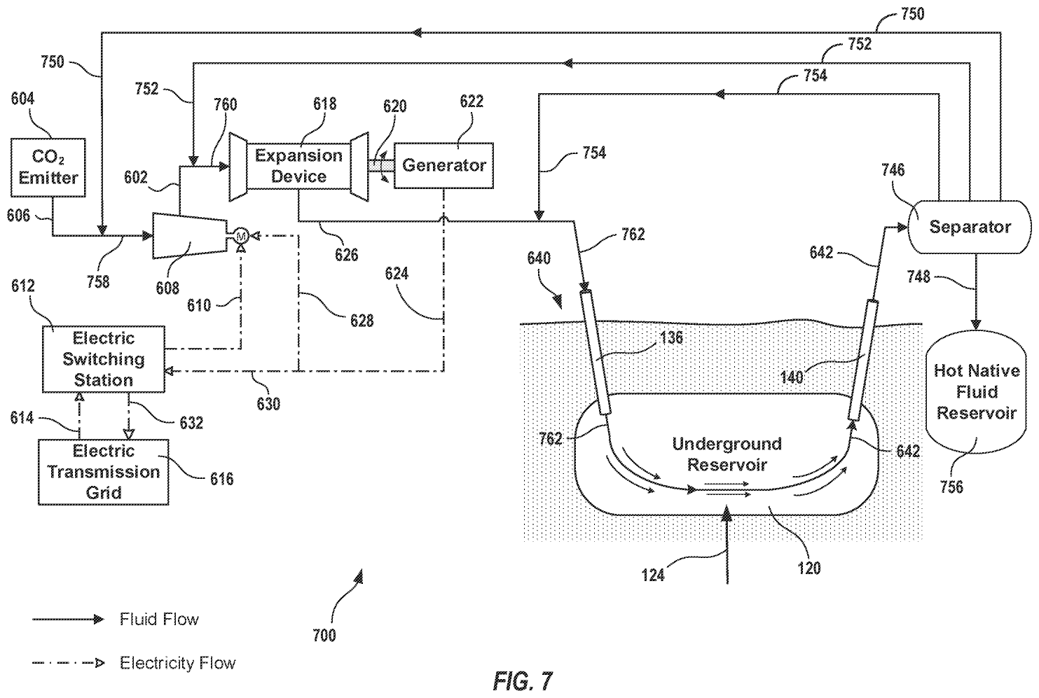

FIG. 7 shows another example of a system 700 that is configured to recapture a portion of excess energy imparted into a compressed CO₂-based stream by a compressor. The main unit operations of the system 700 are essentially identical to those of the system 600 in FIG. 6, and therefore any components of the system 700 that are the same as in the system 600 of FIG. 6 are given the same reference number—i.e., the system 700 also includes a compressed CO₂-based stream 602 a CO₂ emitter 604, a CO₂-based feed stream 606, a compressor 608, electricity 610 to run the compressor 608, an electric switching station 612, electricity 614 provided by an electric transmission grid 616, an expansion device 618 that produces shaft power 620, a generator 622 and its produced electricity 624, a de-energized CO₂-based stream 626, portions 628 and 630 of the generated electricity 624, sold electricity 632, a geothermal energy recovery system 640, and a production fluid 642.

However, the system 700 shown in FIG. 7 includes a different back end from that which is shown in FIG. 6. Specifically, the system 700 of FIG. 7 includes a separation system 746 in place of the energy recovery system 644 (as shown in FIG. 7), or in addition to an energy recovery system (not shown). The separation system 746 can be configured to separate the production fluid 642 into a plurality of substituent streams. In an example, the separation system 746 separates the production fluid 642 into a native fluid stream 748 and one or more working fluid streams 750, 752, and 754 that are each comprised primarily of the working fluid that had been injected into the reservoir 120—that is, the CO₂-based fluid that had formed the de-energized CO₂-based stream 626. The native fluid stream 748 primarily comprises the native fluid that was originally in the reservoir 120 and that had been produced to the surface along with the CO₂-based working fluid stream 626 as part of the production fluid 642, e.g., a brine solution and/or one or more native hydrocarbons. The native fluid stream 748 can be disposed of in a hot native fluid reservoir 756. which can be a man-made vessel or a subterranean reservoir separate from the geothermal reservoir 120. In another example, the separated native fluid stream 748 can be returned to the reservoir 120 to be recombined with the rest of the native fluid in the reservoir 120 rather than being disposed of in the separate reservoir 756.

In an example, the separation system 746 splits the CO₂-based working fluid portion of the production fluid 642 into a first working fluid stream 750, a second working fluid stream 752, and a third working fluid stream 754. The first working fluid stream 750 is combined with the CO₂-based feed stream 606 from the emitter 604 to form a first mixed stream 758 that is recompressed by the compressor 608 to provide the compressed CO₂-based stream 602. The second working fluid stream 752 is combined with the compressed CO₂-based stream 602 output from the compressor 608 to form a second mixed stream 760 that is injected into the expansion device 618 to enhance the shaft power 620 that is produced by the expansion device 618 and increases the amount of electricity 624 produced by the generator 622. The third working fluid stream 754 is combined with the dc-energized CO₂-based fluid 626 that exits the expansion device 618 to form a third mixed stream 762 that can be injected into the reservoir 120 via the injection well 136 to act as the geothermal energy working fluid 762 that passes through the reservoir 120 and becomes the heated production fluid 642.

Those having skill in the art will appreciate that the CO₂-based working fluid from the separation system 746 need not be separated into all three working fluid streams 750, 752, and 754, but rather the system 700 can include only one or two of the three recycle streams. For example, the system could include only the first working fluid stream 750 that combines with the CO₂-based feed stream 606 to form the first mixed stream 758 that is fed into the compressor 608, or only the second working fluid stream 752 that combines with the compressed CO₂-based stream 602 to form the second mixed stream 760 that is fed into the expansion device 618, or only the third working fluid stream 754 that combines with the de-energized CO₂-based stream 626 to form the third mixed stream 762 that is injected into the reservoir 120, or a combination of any two of the three working fluid streams 750, 752, and 754. The separation of the native fluid stream 748 from the one or more working fluid streams 750, 752, 754 allows the system to recycle at least a portion of the CO₂-based working fluid produced from the reservoir 120 to form a geothermal energy recovery cycle.

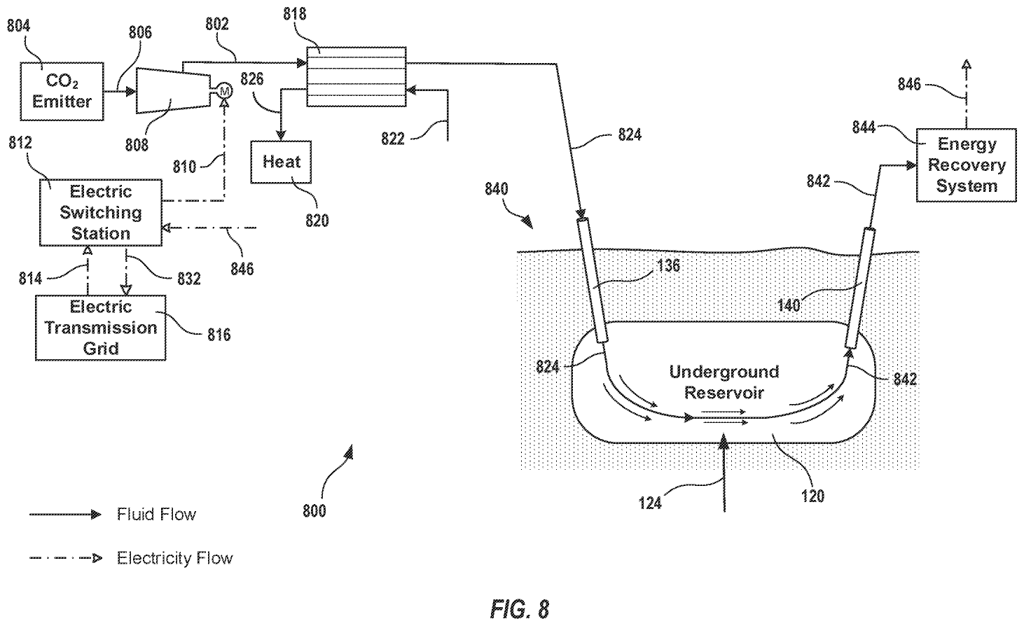

FIG. 8 shows another example of a system 800 that includes components to recover excess energy from a compressed CO₂-based stream 802. Similar to the system 600 of FIG. 6, the system 800 receives a CO-based feed stream 806 from a CO₂ emitter 804 and compresses the CO₂-based feed stream 806 with a compressor 808 to produce the compressed CO₂-based stream 802. The CO₂ emitter 804, the CO₂-based feed stream 806, the compressor 808, and the compressed CO₂-base stream 802 can be similar or identical to the CO₂ emitters 504 and 604, the CO₂-based feed streams 506 and 606, the compressors 508 and 608, and the CO₂-based streams 502 and 602 from the systems 500 and 600 of FIGS. 5 and 6. Similarly, the compressor 808 is at least partially powered by electricity 810, such as electricity delivered from a local electric switching station 812 that, is supplied by electricity 814 from a wide-area electric transmission grid 816. Also, the compressed CO₂-based stream 802 can have parameters that are the same or substantially the same as described above for the compressed CO₂-based streams 502 and 602 from the compressors 508 and 608, e.g., a temperature of at least about 65° C. (at least about 150° F.) and/or no more than about 205° C. (no more than about 400° F.), such as from about 75° C. (about 165° F.) to about 180° C. (about 355° F.), for example from about 90° C. (about 195° F.) to about 150° C. (about 300° F.), such as from about 95° C. (about 200° F.) to about 120° C. (about 250° F.), and a pressure of at least about 17 MPa (at least about 2500 psia) and/or no more than about 27.6 MPa (no more than about 4000 psia), for example from about 19 MPa (2750 psia) to about 26.2 MPa (3800 psia), such as from about 20.7 MPa (3000 psia) to about 24.1 MPa (about 3500 psia).

However, rather than directly generating electricity by passing the compressed CO₂-based stream 802 through an expansion device that drives a generator, the system 800 passes the compressed CO₂-based stream 802 through a heat exchanger 818 to recover at least a portion of excess energy present in the compressed CO₂-based stream 802 and extract it as usable heat energy 820. In an example, the compressed CO₂-based stream 802 is at a first temperature, and a cool working fluid 822 is also fed to the heat exchanger 818 at a second temperature that is lower than the first temperature. The working fluid 822 can flow through the heat exchanger 818 either counter-current relative to the compressed CO₂-based stream 802 (as shown in FIG. 8) or co-current with the compressed CO₂-based stream 802. The lower second temperature of the cool working fluid 822 acts to cool the compressed CO₂-based stream 802 to a third temperature that is lower than the first temperature but higher than the second temperature, to provide a cooled compressed CO₂-based stream 824 (also referred to as the “de-energized CO₂-based stream 824” or the “cooled CO₂-based stream 824”). In an example, the third temperature of the cooled CO₂-based stream 824 is still high enough so that the cooled CO₂-based stream 824 is in a supercritical state.

At the same time, the higher first temperature of the compressed CO₂-based stream 802 acts to heat the cool working fluid 822 to a fourth temperature that is higher than the second temperature, but lower than the first temperature, to provide a heated working fluid 826. The fourth temperature of the heated working fluid 826 may be higher or lower than the third temperature of the cooled CO₂-based stream 824, depending on the configuration and size of the heat exchanger 818.

In an example, the usable heat 820 can be extracted from the heated working fluid 826, e.g., to heat another process stream somewhere else in the system. In an example, the heated working fluid 826 can be a working fluid of a binary energy recovery system. For example, the heated working fluid 826 can be a binary working fluid that is passed through an expansion device to produce shaft power that then drives a generator to produce electricity. After passing through the expansion device, the working fluid can have a reduced temperature due to the expansion device such that it can return to being the cool working fluid 822, which can then be fed back into the heat exchanger 818.

The cooled CO₂-based stream 824 exiting the heat exchanger 818 is the output from the system 800. In other words, the system 800 supplies the cooled CO₂-based stream 824 to any process that requires compressed CO₂, and in particular supercritical CO₂. For example, the cooled CO₂-based stream 824 can be used for any of the purposes for which the de-energized CO₂-based stream 626 is used in the system of FIG. 6. For example, the cooled CO₂-based stream 824 can be injected into a reservoir 120, e.g., for geothermal heat capture in a geothermal energy recovery system 840, for oil or hydrocarbon extraction via enhanced oil recovery (“EOR”), or sequestration of at least a portion of the CO₂-based stream 824.

As with the de-energized CO₂-based fluid 626, the specified temperature and specified pressure of the CO₂-based fluid 824 can depend on the specific application for which the fluid 824 is being used. For example, if the cooled CO₂-based stream 824 is to be used as a working fluid to recover geothermal energy from a reservoir 120, then the specified temperature for the stream 824 can be from about 35° C. (about 100° F.) to about 100° C. (about 215° F.), such as from about 50° C. (about 120° F.) to about 95° C. (about 200° C.) and the specified pressure can be from about 8.3 MPa (about 1200 psia) to about 24.1 MPa (about 3500 psia), such as from about 13.8 MPa (about 2000 psia) to about 20.7 MPa (about 3000 psia). In another example, the cooled CO₂-based stream 824 can be sequestered in the reservoir 120, in which case it may be desirable for the stream 824 to have a similar temperature compared but a lower pressure than when the fluid is used as a geothermal energy recovery working fluid, for example with a specified temperature of from about 35° C. (about 100° F.) to about 100° (about 215° F.), such as from about 50° C. (about 120° F.) to about 95° C. (about 200° C.) and a specified pressure of from about 8.3 MPa (about 1200 psia) to about 20 MPa (about 2900 psia), such as from about 10.3 MPa (about 1500 psia) to about 17.2 MPa (about 2500 psia) In another example, the cooled CO₂-based stream 824 can be used as the working fluid for an enhanced oil recovery (“EOR”) operation, in which case the cooled CO₂-based stream 824 can have a slightly lower temperature and pressure than when the fluid 824 is being used for geothermal energy recovery or sequestration, e.g., with a specified temperature of from about 35° C. (about 100° F.) to about 65° C. (about 150° F.), such as from about 50° C. (about 120° F.) to about 60° C. (140° F.) and a specified pressure of from about 8.3 MPa (1200 psia) to about 15 MPa (2200 psia), such as from about 10.3 MPa (1500 psia) to about 12.3 MPa (about 1800 psia).

In an example, the cooled CO₂-based stream 824 can be fed to the reservoir 120 through the injection well 136 where it flows through the reservoir 120 and absorbs geothermal energy 124 in order to provide a heated production fluid 842. The production fluid 842 can be returned to the surface via a production well 140, where the production fluid 842 can be fed into an energy recovery system 844. The energy recovery system 844 can convert at least a portion of the geothermal heat energy 124 absorbed by the production fluid 842 into another usable form of energy, such as electricity 846. In some examples, at least a portion of the electricity 846 produced by the energy recovery system 844 can be sold by the operator, such as by delivering the produced electricity 846 to the electric switching station 812 where it can be sold back to the electric transmission grid 816 as a portion of the sold electricity 832. A portion of the produced electricity 846 can also be used to power the compressor 808 or another component of the system 600 or the energy recovery system 844 (not shown) without varying from the scope of the invention.

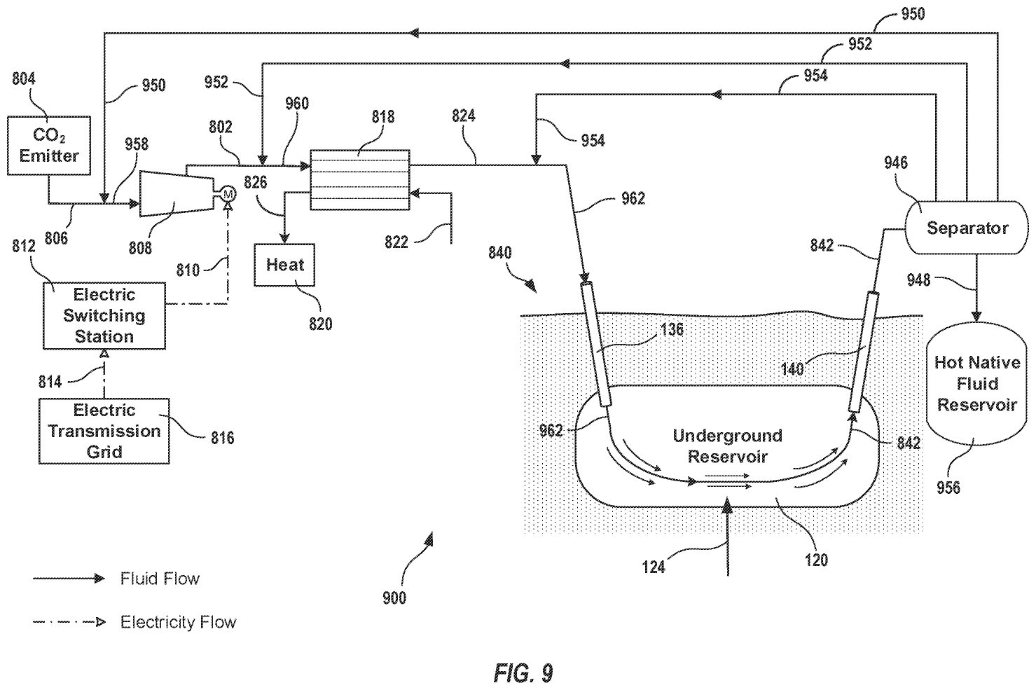

FIG. 9 shows another example of a system 900 that is configured to recapture a portion of excess energy imparted into a compressed CO₂-based stream by a compressor. The main unit operations of the front end of system 900 are essentially identical to those of the system 800 in FIG. 8, and therefore any components of the system 900 that are the same as in the system 800 of FIG. 8 are given the same reference number—i.e., the system 900 also includes a compressed CO₂-based stream 802, a CO₂ emitter 804, a CO₂-based feed stream 806, a compressor 808, electricity 810 to run the compressor 808, an electric switching station 812, electricity 814 provided by an electric transmission grid 816 to the switching station 812, a heat exchanger 818 that recovers excess energy from in the form of heat energy 820 using a secondary working fluid 822 to provide a cooled compressed CO₂-based stream 824 and a warmed working fluid 826; a geothermal energy recovery system 840, and a production fluid 842.

FIG. 9 also includes a back end that is similar to system 700 of FIG. 7, i.e., with a separation system 946 in place of or in addition to an energy recovery system. In an example, the separation system 946 separates the production fluid 842 into a native fluid stream 948 (primarily comprising native fluid from the reservoir 120 that is brought to the surface with the production fluid 842) and one or more working fluid streams 950, 952, 954 (primarily comprising the working fluid that was injected into the reservoir 120, e.g., the CO₂-based working fluid). In an example, the native fluid stream 948 that is discharged from the separation system 946 is disposed of in a hot native fluid reservoir 956, which can be a man-made reservoir or a subterranean reservoir separate from the reservoir 120. In another example, the separated native fluid stream 948 can be returned to the reservoir 120 to be recombined with the rest of the native fluid in the reservoir 120 rather than being disposed of in the separate reservoir 956.

In an example, the separation system 946 splits the CO₂-based working fluid portion of the production fluid 842 into a first working fluid stream 950, a second working fluid stream 952, and a third working fluid stream 954. In an example, the first working fluid stream 950 is combined with the CO₂-based feed stream 806 from the CO₂ emitter 804 to form a first mixed stream 958 that is recompressed by the compressor 608 to provide the compressed CO₂-based stream 802. The second working fluid stream 952 is combined with the compressed CO₂-based stream 802 output from the compressor 808 to form a second mixed stream 960 that sent through the heat exchanger 818 to produce the usable heat energy 820. The third working fluid stream 954 is combined with the cooled CO₂-based stream 824 to form a third mixed stream 962 that can be injected into the reservoir 120 via the injection well 136 to act as the geothermal energy working fluid 962 that passes through the reservoir 120 and becomes the heated production fluid 642.

As with the system 700 of FIG. 7, those having skill in the art will appreciate that the CO₂-based working fluid from the separation system 946 need not be separated into all three working fluid streams 950, 952, and 954, but rather the system 900 can include only one or two of the three recycle streams. For example, the system could include only the first working fluid stream 950 that combines with the CO₂-based feed stream 806 to form the first mixed stream 958 that is fed into the compressor 808, or only the second working fluid stream 952 that combines with the compressed CO₂-based stream 802 to form the second mixed stream 960 that is fed into the heat exchanger 818, or only the third working fluid stream 954 that combines with the cooled CO₂-based stream 824 to form the third mixed stream 962 that is injected into the reservoir 120, or a combination of any two of the three working fluid streams 950, 952, and 954.

The various individual components of the systems 100, 200, 300, and 400 of FIGS. 1-4 and the systems 500, 600, 700, 800, and 900 of FIGS. 5-9 can be obtained and constructed using largely conventional equipment and techniques readily available to those in the geothermal power plant, enhanced oil recovery and/or carbon dioxide sequestration industries. Site locations can be determined using geological survey data for various regions throughout a given country in combination with the storage formation porosity and permeability parameters with an impermeable layer above, described herein as suitable for the method and system of the invention.

The specific materials and designs of additional minor components necessary to perform the process, e.g., valves, pumps, lines, and the like, are understood in the art will not be described herein. The apparatus and method of the invention can further be implemented using a. variety of specific equipment available to and understood by those skilled in process control art. For example, means for sensing temperature, pressure and flow rates in all of the flow lines may accomplished by any suitable means.

It will also be appreciated by those skilled in the art that the invention can include a system controller. Specifically, the system controller can be coupled to various sensing devices to monitor certain variables or physical phenomena, process the variables, and output control signals to control devices to take necessary actions when the variable levels exceed or drop below selected or predetermined values. Such amounts are dependent on other variables and may be varied as desired by using the input device of the controller. Such sensing devices may include, but are not limited to, devices for sensing temperatures, pressures and flow rates, and. transducing the same into proportional electrical signals for transmission to readout or control devices may be provided for in all of the principal fluid flow lines. Such a controller may be a local or remote receiver only, or a computer, such as a laptop or personal computer as is well-known in the art

Additionally, as is known in the art, in implementing the system described herein, general chemical, mechanical and physical engineering principles should be adhered to, including accounting for the various types of energy and materials being input to and output from the system, in order to properly size the system. This includes not only the energy associated with mass flow, but also energy transferred by heat and work. In some examples, the system is optimized for maximum performance utilizing any known optimization methods known in the art.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable Medi urn or machine-readable medium encoded with instructions operable to configure an electronic device to perform methods or method steps as described in the above examples. An implementation of such methods or method steps can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the :like.

The Abstract is provided to comply with 37 C.F.R. § 1.72(b), to allow the reader to quickly ascertain the nature of the technical disclosure. It is submitted with the understanding that it will not be used to interpret or limit the scope or meaning of the claims.

What is claimed is:

1. A system comprising:
a non-water working fluid feed stream;
a compressor configured to compress the non-water based working fluid, to provide a compressed non-water based working fluid; and
an energy recovery system configured to recover energy from the compressed non-water based working fluid, to provide a de-energized compressed non-water based working fluid, wherein the energy recovery system captures at least a portion of excess energy from the compressed non-water based working fluid and converts the captured excess energy to electricity, heat energy, or both electricity and heat energy.

2. The system of claim 1, wherein the excess energy is energy beyond what is necessary for the de-energized compressed non-water based working fluid to be at a specified temperature and a specified pressure.

3. The system of claim 1, wherein the de-energized compressed non-water based working fluid is a supercritical fluid at the specified temperature and the specified pressure.

4. The system of claim 1, wherein the non-water based working fluid primarily comprises carbon dioxide.

5. The system of claim 1, wherein the energy recovery system comprises:
an expansion device that converts at least the portion of energy from the compressed non-water based working fluid to shaft power; and
a generator that converts at least a portion of the shaft power to electricity.

6. The system of claim 1, further comprising:
an injection well for accessing an underground reservoir, the reservoir being at a first temperature, the injection well comprising an injection well inlet and an injection well outlet in fluid communication with the reservoir, wherein the de-energized compressed non-water based working fluid is fed to the injection well inlet, wherein the de-energized compressed non-water based working fluid is at a second temperature that is lower than the first temperature; and
a production well having a production well inlet opening in fluid communication with the reservoir;
wherein exposure of the de-energized compressed non-water based working fluid to the first temperature of the reservoir heats the de-energized compressed non-water based working fluid to provide a heated production fluid at a third temperature that is higher than the second temperature, wherein at least a portion of the heated production fluid enters the production well inlet opening.

7. The system of claim 6, further comprising an energy conversion apparatus in fluid communication with the productions well, wherein the energy conversion apparatus converts energy contained in the production fluid to electricity, heat, or a combination thereof.

8. The system of claim 6, wherein the de-energized compressed non-water based working fluid comprises a supercritical carbon dioxide-based fluid.

9. The system of claim 1, wherein the de-energized compressed non-water based working fluid comprises a compressed carbon dioxide-based fluid, the system further comprising:
an injection well comprising an injection well inlet and an injection well outlet in fluid communication with an underground reservoir, wherein the compressed carbon dioxide-based fluid is fed to the injection well inlet in order to sequester the compressed carbon dioxide-based fluid within the reservoir.

10. The system of claim 9, wherein the compressed carbon dioxide-based fluid is a supercritical fluid.

11. A method comprising:
compressing a non-water based working fluid to provide a compressed non-water based working fluid; and
recovering at least a portion of excess energy from the compressed non-water based working fluid to provide a de-energized compressed non-water based working fluid and converting the recovered energy to electricity, heat energy, or both electricity and heat energy.

12. The method of claim 11, wherein the excess energy is energy beyond what is necessary for the de-energized compressed non-water based working fluid to be at a specified temperature and a specified pressure.

13. The method of claim 12, wherein the de-energized compressed non-water based working fluid is a supercritical fluid at the specified temperature and the specified pressure.

14. The method of claim 11, wherein non-water based working fluid primarily comprises carbon dioxide.

15. The method of claim 11 wherein recovering the energy frog the compressed non-water based working fluid comprises:
passing the compressed non-water based working fluid through an expansion device that converts at least the portion of the energy from the compressed non-water based working fluid to shaft power and provides the de-energized non-water based working fluid; and
converting at least a portion of the shaft power to electricity with an electrical generator.

16. The method of claim 15, further comprising transmitting at least a portion of the electricity to at least one of: a compressor configured to perform the compressing of the non-water based working fluid to provide the compressed non-water based working fluid; an electric switching station; and an electric transmission grid.

17. The method of claim 11, further comprising:
injecting the de-energized compressed non-water based working fluid into an underground reservoir, the reservoir being at a first temperature, wherein the de-energized compressed non-water based working fluid is at a second temperature that is lower than the first temperature;
wherein exposure of the de-energized compressed non-water based working fluid to the first temperature of the reservoir heats the de-energized compressed non-water based working fluid to provide a heated production fluid at a third temperature that is higher than the second temperature; and
producing at least a portion of the heated production fluid from the reservoir.

18. The method of claim 17 further comprising converting energy contained in the production fluid to electricity, heat, or a combination thereof.

19. The method of claim 11 wherein the de-energized compressed non-water based working fluid comprises a compressed carbon dioxide-based fluid, the method further comprising injecting the compressed carbon dioxide-based fluid into an underground reservoir and sequestering the compressed carbon dioxide-based fluid within the reservoir.

20. The method of claim 19, wherein the compressed carbon dioxide-based fluid is a supercritical fluid.
